(19) United States
(12) Patent Application Publication
(10) Pub. No.: US 2025/0026679 A1
(43) Pub. Date: Jan. 23, 2025

(54) ION EXCHANGEABLE HIGH REFRACTIVE INDEX GLASSES

(71) Applicant: CORNING INCORPORATED, CORNING, NY (US)

(72) Inventors: Qiang Fu, Painted Post, NY (US); Xiaoju Guo, Pittsford, NY (US); Jian Luo, Cupertino, CA (US); Lina Ma, Corning, NY (US); Alana Marie Whittier, Painted Post, NY (US)

(21) Appl. No.: 18/713,280

(22) PCT Filed: Nov. 28, 2022
(86) PCT No.: PCT/US2022/051042

§ 371 Date: May 24, 2024

Related U.S. Application Data
(60) Provisional application No. 63/284,063, filed on Nov. 30, 2021.

(51) Int. Cl. C03C 3/097; C03C 21/00

(52) U.S. Cl. CPC C03C 3/097; C03C 21/002

(57) ABSTRACT

A glass is provided, comprising: greater than or equal to 30 mol % to less than or equal to 70 mol % SiO₂, greater than or equal to 0 mol % to less than or equal to 10 mol % B₂O₃, greater than or equal to 1.1 mol % to less than or equal to 12 mol % Al₂O₃, greater than or equal to 3 mol % to less than or equal to 35 mol % Li₂O, greater than or equal to 0 mol % to less than or equal to 20 mol % Na₂O, greater than or equal to 0 mol % to less than or equal to 5 mol % K₂O, greater than or equal to 0 mol % to less than or equal to 5 mol % MgO, greater than or equal to 0 mol % to less than or equal to 5 mol % CaO, greater than or equal to 0 mol % to less than or equal to 5 mol % SrO, greater than or equal to 0 mol % to less than or equal to 5 mol % BaO, greater than or equal to 0 mol % to less than or equal to 5 mol % WO₃, greater than or equal to 0 mol % to less than or equal to 5 mol % Y₂O₃, greater than or equal to 1 mol % to less than or equal to 15 mol % ZrO₂, greater than or equal to 0.1 mol % to less than or equal to 20 mol % Nb₂O₅, greater than or equal to 1 mol % to less than or equal to 20 mol % La₂O₃, greater than or equal to 1 mol % to less than or equal to 20 mol % TiO₂. The glass compositions have a high index of refraction. Related articles, including lenses, are also provided.

This application claims the benefit of priority of U.S. Provisional Application Ser. No. 63/284,063 filed on Nov. 30, 2021, the content of which is relied upon and incorporated herein by reference in its entirety.

### BACKGROUND

### Field

The present specification generally relates to glass compositions suitable for use in applications where a high index of refraction may be desirable, such as lenses used in digital cameras, microscopes and augmented reality devices. More specifically, the present specification is directed to glass compositions and articles having a high index of refraction.

### Technical Background

Digital cameras and augmented reality devices are becoming increasingly common. Such devices are increasingly used in a context where they may experience occasional dropping on hard surfaces, such as the ground, such that the glass may experience impact, bending, or other event that might damage the glass. The functionality of the such devices may be negatively impacted when the glass is damaged.

Chemical strengthening by ion exchange may help the glass resist damage. However, many glass compositions having a high index of refraction are not amenable to the amount of ion exchange needed to impart the desired damage resistance.

Accordingly, a need exists for glasses that can be strengthened, such as by ion exchange, and that have a high index of refraction.

### SUMMARY

According to aspect (1), a glass comprises:
greater than or equal to 30 mol % to less than or equal to 70 mol % SiO₂,
greater than or equal to 0 mol % to less than or equal to 10 mol % B₂O₃,
greater than or equal to 1.1 mol % to less than or equal to 12 mol % Al₂O₃,
greater than or equal to 3 mol % to less than or equal to 35 mol % Li₂O,
greater than or equal to 0 mol % to less than or equal to 20 mol % Na₂O,
greater than or equal to 0 mol % to less than or equal to 5 mol % K₂O,
greater than or equal to 0 mol % to less than or equal to 5 mol % MgO,
greater than or equal to 0 mol % to less than or equal to 5 mol % CaO,
greater than or equal to 0 mol % to less than or equal to 5 mol % SrO,
greater than or equal to 0 mol % to less than or equal to 5 mol % BaO,
greater than or equal to 0 mol % to less than or equal to 5 mol % WO₃,
greater than or equal to 0 mol % to less than or equal to 5 mol % Y₂O₃,
greater than or equal to 1 mol % to less than or equal to 15 mol % ZrO₂,
greater than or equal to 0.1 mol % to less than or equal to 20 mol % Nb₂O₅,
greater than or equal to 1 mol % to less than or equal to 20 mol % La₂O₃,
greater than or equal to 1 mol % to less than or equal to 20 mol % TiO₂.

According to aspect (2), the glass of aspect 1 comprises greater than or equal to 56 mol % to less than or equal to 62 mol % SiO₂.

According to aspect (3), the glass of any of aspects 1 or 2 comprises greater than or equal to 1 mol % to less than or equal to 9 mol % B₂O₃.

According to aspect (4), the glass of any of aspects 1 through 3 comprises greater than or equal to 2 mol % to less than or equal to 9 mol % Al₂O₃.

According to aspect (5), the glass of any of aspects 1 through 4 comprises greater than or equal to 6 mol % to less than or equal to 26 mol % Li₂O.

According to aspect (6), the glass of any of aspects 1 through 5 comprises greater than or equal to 1 mol % to less than or equal to 15 mol % Na₂O.

According to aspect (7), the glass of any of aspects 1 through 6 is substantially free of Na₂O.

According to aspect (8), the glass of any of aspects 1 through 7 comprises greater than or equal to 0.1 mol % to less than or equal to 1 mol % K₂O.

According to aspect (9), the glass of any of aspects 1 through 8 is substantially free of K₂O.

According to aspect (10), the glass of any of aspects 1 through 9 comprises greater than or equal to 0.1 mol % to less than or equal to 1 mol % MgO.

According to aspect (11), the glass of any of aspects 1 through 10 is substantially free of MgO.

According to aspect (12), the glass of any of aspects 1 through 11 comprises greater than or equal to 0.1 mol % to less than or equal to 2 mol % CaO.

According to aspect (13), the glass of any of aspects 1 through 12 is substantially free of CaO.

According to aspect (14), the glass of any of aspects 1 through 13 comprises greater than or equal to 0.1 mol % to less than or equal to 1 mol % SrO.

According to aspect (15), the glass of any of aspects 1 through 14 is substantially free of SrO.

According to aspect (16), the glass of any of aspects 1 through 15 comprises greater than or equal to 0.1 mol % to less than or equal to 1 mol % BaO.

According to aspect (17), the glass of any of aspects 1 through 16 is substantially free of BaO.

According to aspect (18), the glass of any of aspects 1 through 17 comprises greater than or equal to 0 mol % to less than or equal to 5 mol % RO.

According to aspect (19), the glass of any of aspects 1 through 18 is substantially free of WO₃.

According to aspect (20), the glass of any of aspects 1 through 19 is substantially free of Y₂O₃.

According to aspect (21), the glass of any of aspects 1 through 20 comprises greater than or equal to 2 mol % to less than or equal to 6 mol % ZrO₂.

According to aspect (22), the glass of any of aspects 1 through 21 comprises greater than or equal to 3 mol % to less than or equal to 11 mol % Nb₂O₅.

According to aspect (23), the glass of any of aspects 1 through 22 comprises greater than or equal to 2 mol % to less than or equal to 14 mol % La₂O₃.

According to aspect (24), the glass of any of aspects 1 through 23 comprises greater than or equal to 2 mol % to less than or equal to 7 mol % TiO₂.

According to aspect (25), the glass of aspect 1 comprises:
greater than or equal to 56 mol % to less than or equal to 62 mol % SiO₂,
greater than or equal to 0 mol % to less than or equal to 9 mol % B₂O₃,
greater than or equal to 1.1 mol % to less than or equal to 9 mol % Al₂O₃,
greater than or equal to 6 mol % to less than or equal to 26 mol % Li₂O,
greater than or equal to 0 mol % to less than or equal to 15 mol % Na₂O,
greater than or equal to 0 mol % to less than or equal to 1 mol % K₂O,
greater than or equal to 0 mol % to less than or equal to 1 mol % MgO,
greater than or equal to 0 mol % to less than or equal to 2 mol % CaO,
greater than or equal to 0 mol % to less than or equal to 1 mol % SrO,
greater than or equal to 1 mol % to less than or equal to 6 mol % ZrO₂,
greater than or equal to 3 mol % to less than or equal to 11 mol % Nb₂O₅,
greater than or equal to 1 mol % to less than or equal to 14 mol % La₂O₃,
greater than or equal to 1 mol % to less than or equal to 7 mol % TiO₂,
wherein the glass is substantially free of WO₃, Y₂O₃ and BaO.

According to aspect (26), for the glass of any of aspects 1 through 25: ZrO₂+Nb₂O₅+La₂O₃+TiO₂+WO₃ is equal to or greater than 8 mol %.

According to aspect (27), for the glass of aspect 26: ZrO₂+Nb₂O₅+La₂O₃+TiO₂+WO; is equal to or greater than 9 mol %.

According to aspect (28), for the glass of aspect 27: ZrO₂+Nb₂O₅+La₂O₃+TiO₂+WO₃ is equal to or greater than 10 mol %.

According to aspect (29), the glass any of aspects 1 through 28 has a refractive index:
RI at 519 nm greater than or equal to 1.6;
RI at 589.3 nm greater than or equal to 1.6; and
RI at 633 nm greater than or equal to 1.6.

According to aspect (30), an ion-exchanged glass-based lens comprises:
a compressive stress layer extending from a surface of the glass-based article to a depth of compression;
a central tension region; and
a composition at a center of the glass-based lens comprising the composition of any of the glasses of aspects 1 through 29.

### BRIEF DESCRIPTION OF THE DRAWINGS

FIG. 1 schematically depicts a cross section of a glass-based article having compressive stress regions according to embodiments described and disclosed herein;

FIG. 2A is a plan view of an exemplary electronic device incorporating any of the glass-based articles disclosed herein; and

FIG. 2B is a perspective view of the exemplary electronic device of FIG. 2A.

FIG. 3 shows refractive index as a function of mol % Nb₂O₅ plus mol % La₂O₃, for various examples.

FIG. 4 shows transmittance at wavelengths across the visible spectrum and more for a sample of Composition 30 having a 1.0 mm thickness.

FIG. 5 shows a differential scanning calorimetry (DSC) analysis for Compositions 26, 29 and 30.

FIG. 6 shows Central Tension (CT) for a 0.8 mm thick sample of Composition 30 after ion exchange in a bath of 20 NaNO₃/80 KNO₃/0.5 NaNO₃ at 430° C. for various time periods.

FIG. 7 shows weight gain for a 0.8 mm thick sample of Composition 30 after ion exchange in a bath of 20 NaNO₃/80 KNO₃/0.5 NaNO₃ at 430° C. for various time periods.

FIG. 8 shows a lens having compressive stress regions according to embodiments described and disclosed herein.

### DETAILED DESCRIPTION

Reference will now be made in detail to silicate glasses according to various embodiments. The silicate glasses disclosed herein have indices of greater than or equal to 1.6 at various wavelengths across the visible spectrum. The glasses also have good ion exchangeability, such that chemical strengthening processes may be used to achieve high strength and high toughness properties. As such, the glass compositions disclosed herein are useful for applications where a high index of refraction is desirable, and where there may also be the potential for impact or bending events. Lenses for use in cameras and augmented reality devices are two such applications.

Specifically, a specific ion-exchangeable glass composition space is augmented with “index raisers,” namely one or more of ZrO₂, Nb₂O₅, La₂O₃, TiO₂, and WO₃, in order to achieve an ion-exchangeable glass composition with a high index of refraction.

In embodiments of glass compositions described herein, the concentration of constituent components (e.g., SiO₂, Al₂O₃, Li₂O, and the like) are given in mole percent (mol %) on an oxide basis, unless otherwise specified. Components of the glass composition according to embodiments are discussed individually below. It should be understood that any of the variously recited ranges of one component may be individually combined with any of the variously recited ranges for any other component. As used herein, a trailing 0 in a number is intended to represent a significant digit for that number. For example, the number “1.0” includes two significant digits, and the number “1.00” includes three significant digits.

As utilized herein, a “glass-based” substrate refers to an article that is made of glass or glass-ceramic. A “glass-based substrate” includes substrates that have been ion-exchanged, as well as substrates that have not been ion-exchanged. An “article” may be made wholly or partly of glass-based materials, such as glass substrates that include a surface coating, or electronic devices that include a glass substrate. A “substrate” includes a lens. A “lens” has one or more convex or concave surfaces such that it can focus or disperse incident light.

Drop performance is a leading attribute for glass-based articles that may be subject to damage events. Fracture toughness and stress at depth are indicators of improved drop performance on rough surfaces. For this reason, maximizing the amount of stress that can be provided in a glass before reaching frangibility limit increases the stress at depth and the rough surface drop performance. The fracture toughness is known to control the frangibility limit and increasing the fracture toughness increases the frangibility limit. The glass compositions disclosed herein have a high fracture toughness and are capable of achieving high compressive stress levels while remaining non-frangible. These characteristics of the glass compositions enable the development of improved stress profiles designed to address particular failure modes. This capability allows the ion exchanged glass-based articles produced from the glass compositions described herein to be customized with different stress profiles to address particular failure modes of concern.

Glasses disclosed herein can typically be melted at a temperature below 1400° C., in certain embodiments below 1100° C., making it possible to melt in a relatively small commercial glass tank.

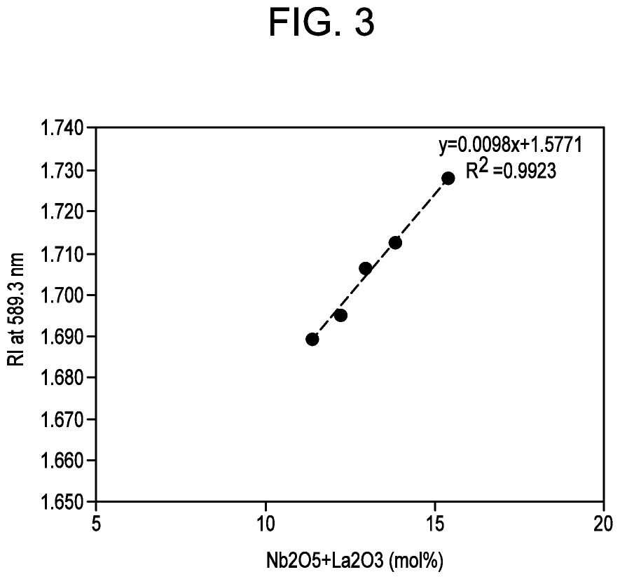

In embodiments, the addition of transition metal oxides or lanthanide oxides can increase the refractive index in the claimed compositions. A linear increase in index was observed with added total amount of Nb₂O₅ and La₂O₃., see FIG. 3. As shown in Table 1, refractive index in the range of 1.6 to 1.9 can be achieved in the claimed composition when a combination of index raisers, including ZnO, Nb₂O₅, La₂O₃, TiO₂, ZrO₂ and WO₃, was present. It is expected that each of these index raisers has a similar effect on index of refraction, even if they are not present in any of the examples.

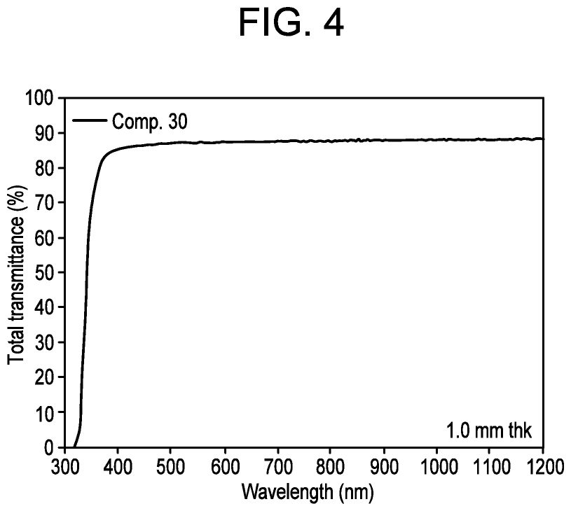

In embodiments, a high transparency can be achieved in the compositions disclosed herein. A total transmittance over 80% in visible and near IR range is shown in FIG. 4 for Composition 30. Similar transparencies were observed visually for the other compositions in Table 1. The high transparency of the glass compositions makes them suitable for uses in optical devices.

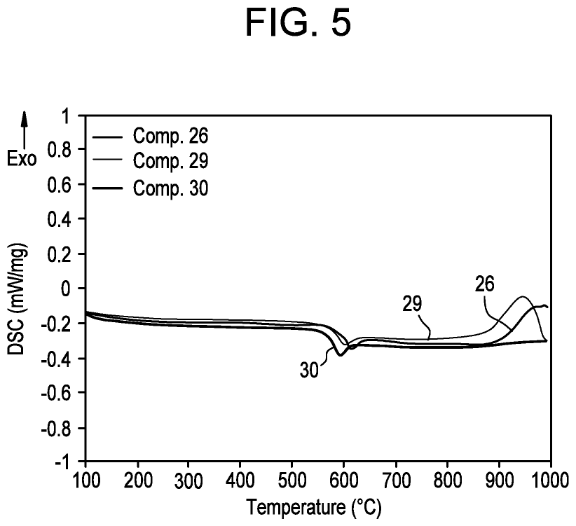

In embodiments, the compositions disclosed herein show good thermal stability on heating. Example compositions (26, 29 and 30) demonstrate an over 200° C. delta temperature between onset of glass transition (Tg) and crystallization (Tc) as determined in a differential scanning calorimetry (DSC) analysis, see FIG. 5. The excellent thermal stability is important for the forming of high-quality glasses and for further thermal processing and treatment.

In embodiments, the compositions disclosed herein have a reasonably low density. All compositions in Table 1 have a density below 4.0 g/cm³. A low density is desired for the targeted application in augmented reality or virtual reality devices or in wearable devices. In comparison, a density of 3.98 g/cm³ is reported for sapphire.

In embodiments, key components that enable efficient ion exchange are included in the compositions disclosed herein. Mobile alkali ions including Li₂O, Na₂O and/or K₂O are included in the claimed compositions to produce ion exchange capability. Additionally, alkali ions can act as a charge compensator at the presence of Al₂O₃ to form [AlO₄] tetrahedra to increase its interdiffusion for efficient ion exchange. A high central tension, up to 190 MPa, was demonstrated in example composition 30 when IOX′d in a 20NaNO₃/80KNO₃/0.5NaNO₂ bath at 430° C. The high stress ensures an improved mechanical reliability for target applications. The stress profile was not optimized for the composition space, so it is expected that more stress can be imparted. Due to similarities in the amounts of the components relevant for ion exchange, it is expected that the other compositions of Table 1 will similarly be ion exchangeable.

In embodiments, the compositions disclosed herein have a high Young's modulus, over 100 GPa, and high fracture toughness, >0.7 MPa·m\hat{ }0.5, both of which are preferred for their mechanical performance.

In embodiments, the compositions disclosed herein have a liquidus viscosity over 100 poise enabling forming through pressing.

### Components

In the glass compositions described herein, SiO₂ is the largest constituent and, as such, SiO₂ is the primary constituent of the glass network formed from the glass composition. Pure SiO₂ has a relatively low CTE. However, pure SiO₂ has a high melting point. Accordingly, if the concentration of SiO₂ in the glass composition is too high, the formability of the glass composition may be diminished as higher concentrations of SiO₂ increase the difficulty of melting the glass, which, in turn, adversely impacts the formability of the glass. Moreover, pure silica has a refractive index of 1.5, which is not favored to achieve high refractive index. If the concentration of SiO₂ in the glass composition is too low the chemical durability of the glass may be diminished, and the glass may be susceptible to surface damage during post-forming treatments. In embodiments, the glass composition generally comprises SiO₂ in an amount of greater than or equal to 30 mol % to less than or equal to 70 mol % SiO₂, such as greater than or equal to 56 mol % to less than or equal to 62 mol % SiO₂; and all ranges and sub-ranges between the foregoing values.

The glass compositions described herein may include B₂O₃. The inclusion of B₂O₃ increases the fracture toughness of the glass. In particular, the glass compositions include boron in the trigonal configuration which increases the Knoop scratch threshold and fracture toughness of the glasses. B₂O₃ may also be included in glass composition to provide stabilization to the network structure. If too much B₂O₃ is included in the composition the amount of compressive stress imparted in an ion exchange process may be reduced and volatility at free surfaces during manufacturing may increase to undesirable levels. In embodiments, the glass composition comprises B₂O₃ in an amount from greater than or equal to 0 mol % to less than or equal to 10 mol %, such as greater than or equal to 1 mol % to less than or equal to 9 mol %, and all ranges and sub-ranges between the foregoing values. In embodiments, the glass composition is substantially free or free of B₂O₃. As used herein, the term “substantially free” means that the component is not purposefully added as a component of the batch material even though the component may be present in the final glass composition in very small amounts as a contaminant, such as less than 0.1 mol %.

The glass compositions include Al₂O₃. Al₂O₃ may serve as a glass network former, similar to SiO₂. Al₂O₃ may increase the viscosity of the glass composition due to its tetrahedral coordination in a glass melt formed from a glass composition, decreasing the formability of the glass composition when the amount of Al₂O₃ is too high. However, when the concentration of Al₂O₃ is balanced against the concentration of SiO₂ and the concentration of alkali oxides in the glass composition, Al₂O₃ can reduce the liquidus temperature of the glass melt, thereby enhancing the liquidus viscosity and improving the compatibility of the glass composition with certain forming processes. The inclusion of Al₂O₃ in the glass compositions contributes to the high fracture toughness values described herein. Al₂O₃ may provide stabilization to the network structure. The addition of Al₂O₃ can form [AlO₄] tetrahedra when alkali ions act as a charge compensator. In embodiments, the glass composition comprises Al₂O₃ in a concentration of from greater than or equal to 1.1 mol % to less than or equal to 12 mol %, such as greater than or equal to 2 mol % to less than or equal to 9 mol %, and all ranges and sub-ranges between the foregoing values.

A combination of alkali metal oxides such as Li₂O, Na₂O and K₂O can be included in the glasses. These oxides can decrease the viscosity of the glass and facilitate melting. They are mobiles ions useful for ion exchange.

The glass compositions include Li₂O. The inclusion of Li₂O in the glass composition allows for better control of an ion exchange process and further reduces the softening point of the glass, thereby increasing the manufacturability of the glass. The presence of Li₂O in the glass compositions also allows the formation of a stress profile with a parabolic shape. The Li₂O in the glass compositions enables the high fracture toughness values described herein. In embodiments, the glass composition comprises Li₂O in an amount from greater than or equal to 3 mol % to less than or equal to 35 mol %, such as greater than or equal to 6 mol % to less than or equal to 26 mol %, and all ranges and sub-ranges between the foregoing values.

The glass compositions described herein may include Na₂O. Na₂O may aid in the ion-exchangeability of the glass composition, and improve the formability, and thereby manufacturability, of the glass composition. However, if too much Na₂O is added to the glass composition, the CTE may be too low, and the melting point may be too high. Additionally, if too much Na₂O is included in the glass relative to the amount of Li₂O the ability of the glass to achieve a deep depth of compression when ion exchanged may be reduced. In embodiments, the glass composition comprises Na₂O in an amount from greater than or equal to 0 mol % to less than or equal to 20 mol %, such as greater than or equal to 1 mol % to less than or equal to 15 mol %, and all ranges and sub-ranges between the foregoing values. In embodiments, the glass composition is substantially free or free of Na₂O.

The glass compositions may include K₂O. The inclusion of K₂O in the glass composition increases the potassium diffusivity in the glass, enabling a deeper depth of a compressive stress spike (DOL_{SP}) to be achieved in a shorter amount of ion exchange time. If too much K₂O is included in the composition the amount of compressive stress imparted during an ion-exchange process may be reduced. In embodiments, the glass composition comprises K₂O in an amount from greater than 0 mol % to less than or equal to 5 mol %, such as greater than or equal to 0.1 mol % to less than or equal to 1 mol %, and all ranges and sub-ranges between the foregoing values. In embodiments, the glass composition is substantially free or free of K₂O.

A combination of alkali-earth metal oxide such as MgO, CaO, SrO and BaO can be included in high refractive index glasses. The alkaline-earth metal oxides contribute to an increase in refractive index of the glass while having a weak influence on dispersion of the glass.

The glass compositions described herein may include MgO. MgO may lower the viscosity of a glass, which enhances the formability and manufacturability of the glass. The inclusion of MgO in a glass composition may also improve the strain point and the Young's modulus of the glass composition. However, if too much MgO is added to the glass composition, the liquidus viscosity may be too low for compatibility with desirable forming techniques. The addition of too much MgO may also increase the density and the CTE of the glass composition to undesirable levels. The inclusion of MgO in the glass composition also helps to achieve the high fracture toughness values described herein. In embodiments, the glass composition comprises MgO in an amount from greater than or equal to 0 mol % to less than or equal to 5 mol %, such as greater than 0.1 mol % to less than or equal to 1 mol %, and all ranges and sub-ranges between the foregoing values. In embodiments, the glass composition is substantially free or free of MgO.

The glass compositions described herein may include CaO. CaO may lower the viscosity of a glass, which may enhance the formability, the strain point, and the Young's modulus. However, if too much CaO is added to the glass composition, the density and the CTE of the glass composition may increase to undesirable levels and the ion exchangeability of the glass may be undesirably impeded. The inclusion of CaO in the glass composition also helps to achieve the high fracture toughness values described herein. In embodiments, the glass composition comprises CaO in an amount from greater than or equal to 0 mol % to less than or equal to 5 mol %, such as greater than or equal to 0.1 mol % to less than or equal to 2 mol %, and all ranges and sub-ranges between the foregoing values. In embodiments, the glass composition is substantially free or free of CaO.

The glass compositions described herein may include SrO. SrO may lower the viscosity of a glass, which may enhance the formability, the strain point, and the Young's modulus. However, if too much SrO is added to the glass composition, the density and the CTE of the glass composition may increase to undesirable levels and the ion exchangeability of the glass may be undesirably impeded. In embodiments, the glass composition comprises SrO in an amount from greater than or equal to 0 mol % to less than or equal to 5 mol %, such as greater than or equal to 0.1 mol % to less than or equal to 1 mol %, and all ranges and sub-ranges between the foregoing values. In embodiments, the glass composition is substantially free or free of SrO.

The glass compositions described herein may include BaO. BaO may lower the viscosity of a glass, which may enhance the formability, the strain point, and the Young's modulus. However, if too much BaO is added to the glass composition, the density and the CTE of the glass composition may increase to undesirable levels and the ion exchangeability of the glass may be undesirably impeded. In embodiments, the glass composition comprises BaO in an amount from greater than or equal to 0 mol % to less than or equal to 5 mol %, such as greater than or equal to 0.1 mol % to less than or equal to 1 mol %, and all ranges and sub-ranges between the foregoing values. In embodiments, the glass composition is substantially free or free of BaO.

RO is the amount of alkali-earth metal oxide present in a composition, i.e., RO═MgO+CaO+SrO+BaO. In embodiments, the glass composition comprises RO in an amount from greater than or equal to 0 mol % to less than or equal to 5 mol %, such as greater than or equal to 0.1 mol % to less than or equal to 1 mol %, and all ranges and sub-ranges between the foregoing values. In embodiments, the glass composition is substantially free or free of RO.

High index constituents (index raisers) allow the compositions disclosed herein to achieve high refractive index. Rare earth oxides including ZnO, Nb₂O₅, TiO₂, La₂O₃, WO₃, and Ta₂O₅ may be added to raise the refractive index of the glass.

The glass compositions described herein may include WO₃. WO₃ increases the refractive index of the glass. However, including too much WO₃ may have deleterious effects. In embodiments, the glass composition comprises WO₃ in an amount from greater than or equal to 0 mol % to less than or equal to 5 mol %. In embodiments, the glass composition is substantially free or free of WO₃.

The glass compositions described herein may include Y₂O₃. Y₂O₃ increases the refractive index of the glass. However, including too much Y₂O₃ may have deleterious effects. In embodiments, the glass composition comprises Y₂O₃ in an amount from greater than or equal to 0 mol % to less than or equal to 5 mol %. In embodiments, the glass composition is substantially free or free of Y₂O₃.

The glass compositions described herein include ZrO₂. The inclusion of ZrO₂ in the glass increases the fracture toughness and allows the glass compositions to achieve the high fracture toughness values described herein due to its high field strength. Including ZrO₂ in the glass composition also improves the chemical durability of the glass. ZrO₂ improves the thermal stability in the Li₂O—SiO₂ glass by significantly reducing glass devitrification during forming and lowering liquidus temperature. ZrO₂ also raises the index of refraction of the glass. As such, ZrO₂ is a particularly desirable component. But, the inclusion of too much ZrO₂ in the glass composition may result in the formation of undesirable zirconia inclusions in the glass, due at least in part to the low solubility of ZrO₂ in the glass. Additionally, there are cost and supply constraints that make including too much ZrO₂ in the glass composition undesirable. In embodiments, the glass composition comprises ZrO₂ in an amount from greater than 1 mol % to less than or equal to 15 mol %, such as greater than or equal to 2 mol % to less than or equal to 6 mol %, and all ranges and sub-ranges between the foregoing values.

The glass compositions described herein include Nb₂O₅. Nb₂O₅ increases the refractive index of the glass. However, including too much Nb₂O₅ may have deleterious effects. In embodiments, the glass composition comprises Nb₂O₅ in an amount from greater than or equal to 0.1 mol % to less than or equal to 20 mol % such as greater than or equal to 3 mol % to less than or equal to 11 mol %, and all ranges and sub-ranges between the foregoing values.

The glass compositions described herein include La₂O₃. La₂O₃ increases the refractive index of the glass. La₂O₃ also increases the fracture toughness, and as such is a particularly desirable component. However, including too much La₂O₃ may have deleterious effects. In embodiments, the glass composition comprises La₂O₃ in an amount from greater than or equal to 1 mol % to less than or equal to 20 mol % such as greater than or equal to 2 mol % to less than or equal to 14 mol %, and all ranges and sub-ranges between the foregoing values.

The glass compositions described herein include TiO₃. TiO₃ increases the refractive index of the glass. However, including too much TiO₃ may have deleterious effects. In embodiments, the glass composition comprises TiO₃ in an amount from greater than or equal to 1 mol % to less than or equal to 20 mol % such as greater than or equal to 2 mol % to less than or equal to 7 mol %, and all ranges and sub-ranges between the foregoing values.

The glass compositions may optionally include one or more fining agents. In embodiments, the fining agent may include, for example, SnO₂. In embodiments, SnO₂ may be present in the glass composition in an amount less than or equal to 0.2 mol %, such as from greater than or equal to 0 mol % to less than or equal to 0.2 mol %, greater than or equal to 0 mol % to less than or equal to 0.1 mol %, greater than or equal to 0 mol % to less than or equal to 0.05 mol %, greater than or equal to 0.1 mol % to less than or equal to 0.2 mol %, and all ranges and sub-ranges between the foregoing values. In some embodiments, the glass composition may be substantially free or free of SnO₂. In embodiments, the glass composition may be substantially free of one or both of arsenic and antimony. In other embodiments, the glass composition may be free of one or both of arsenic and antimony.

In order to achieve the desired refractive index of 1.6 at various points across the visible spectrum, such as at 519 nm, 589.3 nm and 633 nm, a combination of index raisers are included in the glass composition. Including too much of any given index raiser may lead to deleterious effects, so it is preferred to include a combination of index raisers. The index raisers discussed herein are ZrO₂, Nb₂O₅, La₂O₃, TiO₂, WO₃ and Y₂O₃. In embodiments, ZrO₂+Nb₂O₅+La₂O₃+TiO₂+WO₃+Y₂O₃ is equal to or greater than 8 mol %, 9 mol % or 10 mol %. In embodiments, ZrO₂+Nb₂O₅+La₂O₃+TiO₂ is equal to or greater than 8 mol %, 9 mol % or 10 mol %.

The glass compositions described herein may be formed primarily from SiO₂, Al₂O₃, CaO, Li₂O, ZrO₂, Nb₂O₅, La₂O₃, and TiO₃, and optionally B₂O₃, Na₂O, K₂O MgO, CaO, SrO, and WO₃. In embodiments, the glass compositions are substantially free or free of components other than SiO₂, Al₂O₃, CaO, Li₂O, ZrO₂, Nb₂O₅, La₂O₃, and TiO₃, and optionally B₂O₃, Na₂O, K₂O MgO, CaO, SrO, WO₃, and fining agents, in the amounts specified herein. In embodiments, the glass compositions are substantially free or free of components other than SiO₂, Al₂O₃, CaO, Li₂O, ZrO₂, Nb₂O₅, La₂O₃, and TiO₃, and fining agents.

In embodiments, the glass composition may be substantially free or free of Fe₂O₃. Iron is often present in raw materials utilized to form glass compositions, and as a result may be detectable in the glass compositions described herein even when not actively added to the glass batch.

In embodiments, the glass composition may be substantially free or free of at least one of Ta₂O₅, HfO₂, and Y₂O₃. While these components may increase the fracture toughness of the glass when included, there are cost and supply constraints that make using these components undesirable for commercial purposes. Stated differently, the ability of the glass compositions described herein to achieve high fracture toughness values without the inclusion of Ta₂O₅, HfO₂, and Y₂O₃ provides a cost and manufacturability advantage.

Physical properties of the glass compositions as disclosed above will now be discussed.

### Glass and Glass-Ceramic

In one or more embodiments, the glass compositions described herein may form glass-based articles that exhibit an amorphous microstructure and may be substantially free of crystals or crystallites. In other words, the glass-based articles formed from the glass compositions described herein may exclude glass-ceramic materials.

### Strengthened Glass

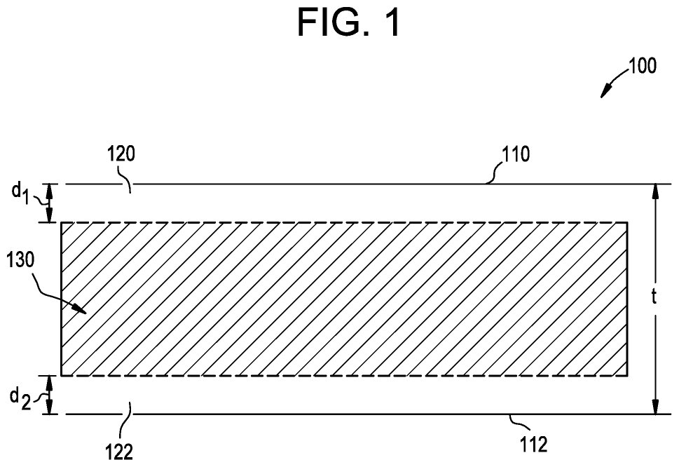

In embodiments, the glass compositions described herein can be strengthened, such as by ion exchange, making a glass-based article that is damage resistant for applications such as, but not limited to, display covers. With reference to FIG. 1, a glass-based article 100 is depicted that has a first region under compressive stress (e.g., first and second compressive layers 120, 122 in FIG. 1) extending from the surface to a depth of compression (DOC) of the glass-based article and a second region (e.g., central region 130 in FIG. 1) under a tensile stress or central tension (CT) extending from the DOC into the central or interior region of the glass-based article. As used herein, DOC refers to the depth at which the stress within the glass-based article changes from compressive to tensile. At the DOC, the stress crosses from a positive (compressive) stress to a negative (tensile) stress and thus exhibits a stress value of zero.

According to the convention normally used in the art, compression or compressive stress is expressed as a negative (<0) stress and tension or tensile stress is expressed as a positive (>0) stress. Throughout this description, however, CS is expressed as a positive or absolute value—i.e., as recited herein, CS=|CS|. The compressive stress (CS) has a maximum at or near the surface of the glass-based article, and the CS varies with distance d from the surface according to a function. Referring again to FIG. 1, a first segment 120 extends from first surface 110 to a depth d₁ and a second segment 122 extends from second surface 112 to a depth d₂. Together, these segments define a compression or CS of glass-based article 100. Compressive stress (including surface CS) may be measured by surface stress meter (FSM) using commercially available instruments such as the FSM-6000, manufactured by Orihara Industrial Co., Ltd. (Japan). Surface stress measurements rely upon the accurate measurement of the stress optical coefficient (SOC), which is related to the birefringence of the glass. SOC in turn is measured according to Procedure C (Glass Disc Method) described in ASTM standard C770-16, entitled “Standard Test Method for Measurement of Glass Stress-Optical Coefficient,” the contents of which are incorporated herein by reference in their entirety.

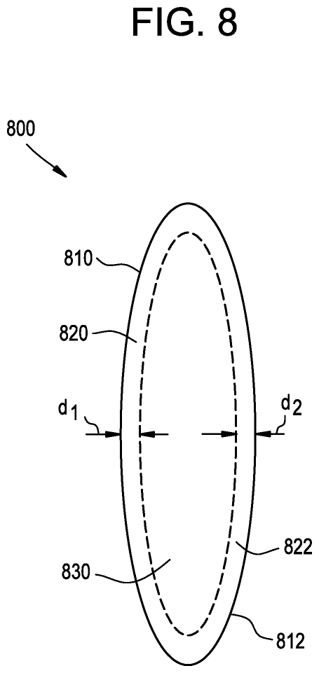

FIG. 8 shows a glass-based lens 800. Lens 800 has a different shape from glass-based article 100 of FIG. 1. But, similar to glass-based article 100, lens 800 has a first region under compressive stress (e.g., first and second compressive layers 820, 822 in FIG. 8) extending from the surface to a depth of compression (DOC) of the glass-based article and a second region (e.g., central region 830 in FIG. 8) under a tensile stress or central tension (CT) extending from the DOC into the central or interior region of the glass-based article. Referring again to FIG. 8, first compressive layer 820 extends from first surface 810 to a depth d₁ and a second compressive layer 822 extends from second surface 812 to a depth d₂. Together, these compressive layers define a compression or CS of glass-based article 100. While lens 800 is illustrated as a double convex lens, the lens may more generally be any shape that focuses or diffuses light. A high index of refraction makes a lens more effective at such focus or diffraction.

In embodiments, Na⁺ and K⁺ ions are exchanged into the glass-based article and the Na⁺ ions diffuse to a deeper depth into the glass-based article than the K⁺ ions. The depth of penetration of K⁺ ions (“Potassium DOL”) is distinguished from DOC because it represents the depth of potassium penetration as a result of an ion exchange process. The Potassium DOL is typically less than the DOC for the articles described herein. Potassium DOL is measured using a surface stress meter such as the commercially available FSM-6000 surface stress meter, manufactured by Orihara Industrial Co., Ltd. (Japan), which relies on accurate measurement of the stress optical coefficient (SOC), as described above with reference to the CS measurement. The potassium DOL may define a depth of a compressive stress spike (DOL_{SP}), where a stress profile transitions from a steep spike region to a less-steep deep region. The deep region extends from the bottom of the spike to the depth of compression.

The compressive stress of both major surfaces (110, 112 in FIG. 1) is balanced by stored tension in the central region (130) of the glass-based article. The maximum central tension (CT) and DOC values may be measured using a scattered light polariscope (SCALP) technique known in the art. The refracted near-field (RNF) method or SCALP may be used to determine the stress profile of the glass-based articles. When the RNF method is utilized to measure the stress profile, the maximum CT value provided by SCALP is utilized in the RNF method. In particular, the stress profile determined by RNF is force balanced and calibrated to the maximum CT value provided by a SCALP measurement. The RNF method is described in U.S. Pat. No. 8,854,623, entitled “Systems and methods for measuring a profile characteristic of a glass sample”, which is incorporated herein by reference in its entirety. In particular, the RNF method includes placing the glass-based article adjacent to a reference block, generating a polarization-switched light beam that is switched between orthogonal polarizations at a rate of between 1 Hz and 50 Hz, measuring an amount of power in the polarization-switched light beam and generating a polarization-switched reference signal, wherein the measured amounts of power in each of the orthogonal polarizations are within 50% of each other. The method further includes transmitting the polarization-switched light beam through the glass sample and reference block for different depths into the glass sample, then relaying the transmitted polarization-switched light beam to a signal photodetector using a relay optical system, with the signal photodetector generating a polarization-switched detector signal. The method also includes dividing the detector signal by the reference signal to form a normalized detector signal and determining the profile characteristic of the glass sample from the normalized detector signal.

The measurement of a maximum CT value is an indicator of the total amount of stress stored in the strengthened articles, due to the force balancing described above. For this reason, the ability to achieve higher CT values correlates to the ability to achieve higher degrees of strengthening and increased performance. In embodiments, the glass-based articles may have a maximum CT greater than or equal to 60 MPa, such as greater than or equal to 100 MPa, such as greater than or equal to 120 MPa, greater than or equal to 140 MPa, greater than or equal to 160 MPa, greater than or equal to 180 MPa, or more. In embodiments, the glass-based article may have a maximum CT of from greater than or equal to 60 MPa to less than or equal to 1.5 GPa, and all ranges and sub-ranges between the foregoing values in this paragraph.

As noted above, DOC is measured using a scattered light polariscope (SCALP) technique known in the art. The DOC may be provided as a portion of the thickness (t) of the glass-based article.

The ion-exchange conditions disclosed herein were not optimized for the glass compositions disclosed herein. As such, the data demonstrates that IOX is effective for these compositions and provides some examples of parameters that can be achieved. However, it is expected based on the disclosure herein that better parameters may be achieved, such as higher CT.

### Thickness

Thickness (t) of glass-based article 100 is measured between surface 110 and surface 112. In embodiments, the thickness of glass-based article 100 may be in a range from greater than or equal to 0.1 mm to less than or equal to 4 mm, such as greater than or equal to 0.2 mm to less than or equal to 3.5 mm, greater than or equal to 0.3 mm to less than or equal to 3 mm, greater than or equal to 0.4 mm to less than or equal to 2.5 mm, greater than or equal to 0.5 mm to less than or equal to 2 mm, greater than or equal to 0.6 mm to less than or equal to 1.5 mm, greater than or equal to 0.7 mm to less than or equal to 1 mm, greater than or equal to 0.2 mm to less than or equal to 2 mm, and all ranges and sub-ranges between the foregoing values. The glass substrate utilized to form the glass-based article may have the same thickness as the thickness desired for the glass-based article. More generally, any thickness suitable for a lens may be used. Such thicknesses may be outside the ranges discussed in this paragraph.

### Ion Exchange

Compressive stress layers may be formed in the glass by exposing the glass to an ion exchange medium. In embodiments, the ion exchange medium may be molten nitrate salt. In embodiments, the ion exchange medium may be a molten salt bath, and may include KNO₃, NaNO₃, or combinations thereof. In embodiments, other sodium and potassium salts may be used in the ion exchange medium, such as, for example sodium or potassium nitrites, phosphates, or sulfates. In embodiments, the ion exchange medium may include lithium salts, such as LiNO₃. The ion exchange medium may additionally include additives commonly included when ion exchanging glass, such as silicic acid. The ion exchange process is applied to a glass-based substrate to form a glass-based article that includes a compressive stress layer extending from a surface of the glass-based article to a depth of compression and a central tension region. The glass-based substrate utilized in the ion exchange process may include any of the glass compositions described herein.

In embodiments, the ion exchange medium comprises NaNO₃. The sodium in the ion exchange medium exchanges with lithium ions in the glass to produce a compressive stress. In embodiments, the ion exchange medium may include NaNO₃ in an amount of less than or equal to 95 wt %, such as less than or equal to 90 wt %, less than or equal to 80 wt %, less than or equal to 70 wt %, less than or equal to 60 wt %, less than or equal to 50 wt %, less than or equal to 40 wt %, less than or equal to 30 wt %, less than or equal to 20 wt %, less than or equal to 10 wt %, or less. In embodiments, the ion exchange medium may include NaNO₃ in an amount of greater than or equal to 5 wt %, such as greater than or equal to 10 wt %, greater than or equal to 20 wt %, greater than or equal to 30 wt %, greater than or equal to 40 wt %, greater than or equal to 50 wt %, greater than or equal to 60 wt %, greater than or equal to 70 wt %, greater than or equal to 80 wt %, greater than or equal to 90 wt %, or more. In embodiments, the ion exchange medium may include NaNO₃ in an amount of greater than or equal to 0 wt % to less than or equal to 100 wt %, such as greater than or equal to 10 wt % to less than or equal to 90 wt %, greater than or equal to 20 wt % to less than or equal to 80 wt %, greater than or equal to 30 wt % to less than or equal to 70 wt %, greater than or equal to 40 wt % to less than or equal to 60 wt %, greater than or equal to 50 wt % to less than or equal to 90 wt %, and all ranges and sub-ranges between the foregoing values. In embodiments, the molten ion exchange medium includes 100 wt % NaNO₃.

In embodiments, the ion exchange medium comprises KNO₃. In embodiments, the ion exchange medium may include KNO₃ in an amount of less than or equal to 95 wt %, such as less than or equal to 90 wt %, less than or equal to 80 wt %, less than or equal to 70 wt %, less than or equal to 60 wt %, less than or equal to 50 wt %, less than or equal to 40 wt %, less than or equal to 30 wt %, less than or equal to 20 wt %, less than or equal to 10 wt %, or less. In embodiments, the ion exchange medium may include KNO₃ in an amount of greater than or equal to 5 wt %, such as greater than or equal to 10 wt %, greater than or equal to 20 wt %, greater than or equal to 30 wt %, greater than or equal to 40 wt %, greater than or equal to 50 wt %, greater than or equal to 60 wt %, greater than or equal to 70 wt %, greater than or equal to 80 wt %, greater than or equal to 90 wt %, or more. In embodiments, the ion exchange medium may include KNO₃ in an amount of greater than or equal to 0 wt % to less than or equal to 100 wt %, such as greater than or equal to 10 wt % to less than or equal to 90 wt %, greater than or equal to 20 wt % to less than or equal to 80 wt %, greater than or equal to 30 wt % to less than or equal to 70 wt %, greater than or equal to 40 wt % to less than or equal to 60 wt %, greater than or equal to 50 wt % to less than or equal to 90 wt %, and all ranges and sub-ranges between the foregoing values. In embodiments, the molten ion exchange medium includes 100 wt % KNO₃.

The ion exchange medium may include a mixture of sodium and potassium. In embodiments, the ion exchange medium is a mixture of potassium and sodium, such as a molten salt bath that includes both NaNO₃ and KNO₃. In embodiments, the ion exchange medium may include any combination NaNO₃ and KNO₃ in the amounts described above, such as a molten salt bath containing 80 wt % NaNO₃ and 20 wt % KNO₃.

The glass composition may be exposed to the ion exchange medium by dipping a glass substrate made from the glass composition into a bath of the ion exchange medium, spraying the ion exchange medium onto a glass substrate made from the glass composition, or otherwise physically applying the ion exchange medium to a glass substrate made from the glass composition to form the ion exchanged glass-based article. Upon exposure to the glass composition, the ion exchange medium may, according to embodiments, be at a temperature from greater than or equal to 360° C. to less than or equal to 500° C., such as greater than or equal to 370° C. to less than or equal to 490° C., greater than or equal to 380° C. to less than or equal to 480° C., greater than or equal to 390° C. to less than or equal to 470° C., greater than or equal to 400° C. to less than or equal to 460° C., greater than or equal to 410° C. to less than or equal to 450° C., greater than or equal to 420° C. to less than or equal to 440° C., greater than or equal to 430° C. to less than or equal to 470° C., greater than or equal to 400° C. to less than or equal to 470° C., greater than or equal to 380° C. to less than or equal to 470° C., and all ranges and sub-ranges between the foregoing values. In embodiments, the glass composition may be exposed to the ion exchange medium for a duration from greater than or equal to 10 minutes to less than or equal to 48 hours, such as greater than or equal to 10 minutes to less than or equal to 24 hours, greater than or equal to 0.5 hours to less than or equal to 24 hours, greater than or equal to 1 hours to less than or equal to 18 hours, greater than or equal to 2 hours to less than or equal to 12 hours, greater than or equal to 4 hours to less than or equal to 8 hours, and all ranges and sub-ranges between the foregoing values.

The ion exchange process may include a second ion exchange treatment. In embodiments, the second ion exchange treatment may include ion exchanging the glass-based article in a second molten salt bath. The second ion exchange treatment may utilize any of the ion exchange mediums described herein. In embodiments, the second ion exchange treatment utilizes a second molten salt bath that includes KNO₃.

The ion exchange process may be performed in an ion exchange medium under processing conditions that provide an improved compressive stress profile as disclosed, for example, in U.S. Patent Application Publication No. 2016/0102011, which is incorporated herein by reference in its entirety. In some embodiments, the ion exchange process may be selected to form a parabolic stress profile in the glass-based articles, such as those stress profiles described in U.S. Patent Application Publication No. 2016/0102014, which is incorporated herein by reference in its entirety.

After an ion exchange process is performed, it should be understood that a composition at the surface of an ion exchanged glass-based article is be different than the composition of the as-formed glass substrate (i.e., the glass substrate before it undergoes an ion exchange process). This results from one type of alkali metal ion in the as-formed glass substrate, such as, for example Li⁺ or Na⁺, being replaced with larger alkali metal ions, such as, for example Na⁺ or K⁺, respectively. However, the glass composition at or near the center of the depth of the glass-based article will, in embodiments, still have the composition of the as-formed non-ion exchanged glass substrate utilized to form the glass-based article. As utilized herein, the center of the glass-based article refers to any location in the glass-based article that is a distance of at least 0.5 from every surface thereof, where t is the thickness of the glass-based article.

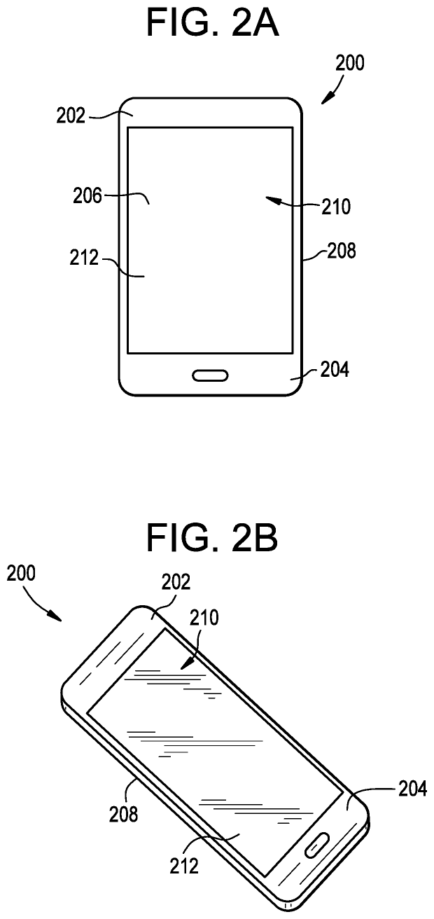

The glass-based articles disclosed herein may be incorporated into another article such as an article with a display (or display articles) (e.g., consumer electronics, including mobile phones, tablets, computers, navigation systems, and the like), architectural articles, transportation articles (e.g., automobiles, trains, aircraft, sea craft, etc.), appliance articles, or any article that requires some transparency, scratch-resistance, abrasion resistance or a combination thereof. An exemplary article incorporating any of the glass-based articles disclosed herein is shown in FIGS. 2A and 2B. Specifically, FIGS. 2A and 2B show a consumer electronic device 200 including a housing 202 having front 204, back 206, and side surfaces 208; electrical components (not shown) that are at least partially inside or entirely within the housing and including at least a controller, a memory, and a display 210 at or adjacent to the front surface of the housing; and a cover 212 at or over the front surface of the housing such that it is over the display. In embodiments, at least a portion of at least one of the cover 212 and the housing 202 may include any of the glass-based articles described herein. In embodiments, the glass-based articles disclosed herein are lenses.

### EXAMPLES

Embodiments will be further clarified by the following examples. It should be understood that these examples are not limiting to the embodiments described above.

Glass compositions were prepared and analyzed. The analyzed glass compositions for Samples 1 through 31 included the components listed in Table 1 below and were prepared by conventional glass forming methods. In Table 1, all components are in mol %, and the K_{IC} fracture toughness was measured primarily with the chevron notch (CNSB) method described herein. The Poisson's ratio (v), the Young's modulus (E), and the shear modulus (G) of the glass compositions were measured by a resonant ultrasonic spectroscopy technique of the general type set forth in ASTM E2001-13, titled “Standard Guide for Resonant Ultrasound Spectroscopy for Defect Detection in Both Metallic and Non-metallic Parts.”. The refractive index at various wavelengths and stress optical coefficient (SOC) of the substrates are also reported in Table 1. The density of the glass compositions was determined using the buoyancy method of ASTM C693-93 (2013).

The term “annealing point,” as used herein, refers to the temperature at which the viscosity of the glass composition is 1×10^{13.18} poise. The term “strain point,” as used herein, refers to the temperature at which the viscosity of the glass composition is 1×10^{14.68} poise. The strain point and annealing point of the glass compositions was determined using the fiber elongation method of ASTM C336-71 (2015) or the beam bending viscosity (BBV) method of ASTM C598-93 (2013).

The term “softening point,” as used herein, refers to the temperature at which the viscosity of the glass composition is 1×10^{7.6} poise. The softening point of the glass compositions was determined using the fiber elongation method of ASTM C336-71 (2015) or a parallel plate viscosity (PPV) method which measures the viscosity of inorganic glass from 10⁷ to 10⁹ poise as a function of temperature, similar to ASTM C1351M.

Both before and after ion exchange, every sample was visually observed to have a transparency suitable for a lens used for visible light, for example for photography or a virtual reality headset.

TABLE 1
Table 1. Example compositions produced at Advanced Materials Processing Lab (AMPL). Density was measured
using the Archimedes' method, and refractive index (RI) using an PerkinElmer 950 spectrometer.

| | Composition | | | | | |
|---|---|---|---|---|---|---|
| (mol %) | 1 | 2 | 3 | 4 | 5 | 6 |
| SiO₂ | 61.8 | 60.5 | 57.2 | 58.0 | 57.3 | 56.5 |
| B₂O₃ | 9.2 | 9 | 0.0 | 0.0 | 0.0 | 0.0 |
| Al₂O₃ | 2.8 | 2.7 | 0.8 | 0.0 | 0.7 | 1.5 |
| Li₂O | 6.4 | 6.2 | 25.4 | 17.3 | 20.9 | 25.4 |
| Na₂O | 7.1 | 7 | 0.0 | 8.1 | 4.5 | 0.0 |
| K₂O | 0.6 | 0.6 | 0.0 | 0.0 | 0.0 | 0.0 |
| MgO | 1 | 1 | 0.0 | 0.0 | 0.0 | 0.0 |
| CaO | 1.3 | 1.2 | 0.0 | 0.0 | 0.0 | 0.0 |
| SrO | 0.5 | 0.5 | 0.0 | 0.0 | 0.0 | 0.0 |
| ZrO₂ | 3.4 | 3.3 | 5.2 | 5.2 | 5.2 | 5.2 |
| Nb₂O₅ | 6 | 8 | 4.9 | 4.9 | 4.9 | 4.9 |
| La₂O₃ | 0 | 0 | 6.5 | 6.5 | 6.5 | 6.5 |
| Total | 100.1 | 100.0 | 100.0 | 100.0 | 100.0 | 100.0 |
| RI at 519 nm | | 1.648 | 1.713 | 1.700 | 1.707 | 1.707 |
| RI at 589.3 nm | 1.614 | 1.64 | 1.7040 | 1.6950 | 1.7010 | 1.7010 |
| RI at 633 nm | | 1.637 | 1.700 | 1.693 | 1.698 | 1.699 |

| | Composition | | | | | |
|---|---|---|---|---|---|---|
| (mol %) | 7 | 8 | 9 | 10 | 11 | 12 |
| SiO₂ | 57.3 | 56.7 | 55.9 | 57.2 | 56.6 | 56.0 |
| Al₂O₃ | 0.7 | 1.3 | 2.1 | 0.8 | 1.4 | 2.0 |
| Li₂O | 17.7 | 20.9 | 25.4 | 14.2 | 17.2 | 20.5 |
| Na₂O | 7.7 | 4.5 | 0.0 | 11.2 | 8.2 | 4.9 |
| ZrO₂ | 5.2 | 5.2 | 5.2 | 5.2 | 5.2 | 5.2 |
| Nb₂O₅ | 4.9 | 4.9 | 4.9 | 4.9 | 4.9 | 4.9 |
| La₂O₃ | 6.5 | 6.5 | 6.5 | 6.5 | 6.5 | 6.5 |
| Total | 100.0 | 100.0 | 100.0 | 100.0 | 100.0 | 100.0 |
| RI at 519 nm | 1.704 | 1.704 | 1.709 | 1.693 | 1.699 | 1.708 |
| RI at 589.3 nm | 1.6950 | 1.6970 | 1.7020 | 1.6880 | 1.6920 | 1.7000 |
| RI at 633 nm | 1.691 | 1.694 | 1.698 | 1.686 | 1.689 | 1.697 |

Composition

| (mol %) | 13 | 14 | 15 | 16 |
|---|---|---|---|---|
| SiO₂ | 55.0 | 46.4 | 48.9 | 47.3 |
| Al₂O₃ | 3.0 | 3.4 | 2.9 | 5.4 |
| Li₂O | 25.4 | 15.4 | 15.4 | 15.4 |
| Na₂O | 0.0 | 10.0 | 10.0 | 10.0 |
| ZrO₂ | 5.2 | 5.2 | 5.2 | 5.2 |
| Nb₂O₅ | 4.9 | 8.4 | 7.5 | 7.2 |
| La₂O₃ | 6.5 | 11.2 | 10.1 | 9.5 |
| Total | 100.0 | 100.0 | 100.0 | 100.0 |
| RI at 519 nm | 1.711 | 1.7798 | 1.7622 | 1.7455 |
| RI at 589.3 nm | 1.7030 | 1.773 | 1.751 | 1.738 |
| RI at 633 nm | 1.700 | 1.7696 | 1.7459 | 1.7340 |

| | Composition | | | | | | | |
|---|---|---|---|---|---|---|---|---|
| (mol %) | 17 | 18 | 19 | 20 | 21 | 22 | 23 | 24 |
| SiO₂ | 50.6 | 49.6 | 48.1 | 54.0 | 52.5 | 51.4 | 50.4 | 49.0 |
| Al₂O₃ | 2.7 | 4.7 | 7.1 | 0.0 | 2.7 | 4.7 | 6.5 | 9.0 |
| Li₂O | 15.4 | 15.4 | 15.4 | 15.4 | 15.4 | 15.4 | 15.4 | 15.4 |
| Na₂O | 10.0 | 10.0 | 10.0 | 10.0 | 10.0 | 10.0 | 10.0 | 10.0 |
| ZrO₂ | 5.2 | 5.2 | 5.2 | 5.2 | 5.2 | 5.2 | 5.2 | 5.2 |
| Nb₂O₅ | 6.9 | 6.5 | 6.1 | 6.6 | 6.1 | 5.7 | 5.4 | 4.9 |
| La₂O₃ | 9.2 | 8.6 | 8.1 | 8.8 | 8.1 | 7.6 | 7.1 | 6.5 |
| Total | 100.0 | 100.0 | 100.0 | 100.0 | 100.0 | 100.0 | 100.0 | 100.0 |
| RI at 519 nm | 1.7418 | 1.7315 | 1.7187 | 1.7396 | 1.7235 | 1.7120 | 1.6995 | 1.6874 |
| RI at 589.3 nm | 1.735 | 1.723 | 1.710 | 1.731 | 1.715 | 1.705 | 1.692 | 1.680 |
| RI at 633 nm | 1.7314 | 1.7197 | 1.7054 | 1.7277 | 1.7118 | 1.7015 | 1.6882 | 1.6763 |

| | Composition | | | | | | |
|---|---|---|---|---|---|---|---|
| (mol %) | 25 | 26 | 27 | 28 | 29 | 30 | 31 |
| SiO₂ | 55.5 | 53.2 | 52.8 | 52 | 53.2 | 53.2 | 53.2 |
| Al₂O₃ | 1.7 | 2.3 | 3.6 | 6 | 2.3 | 2.3 | 2.3 |
| Li₂O | 15.4 | 15.4 | 15.4 | 15.4 | 15.4 | 15.4 | 13.4 |
| Na₂O | 10 | 10 | 10 | 10 | 10 | 10 | 10 |
| K₂O | 0 | 0 | 0 | 0 | 0 | 0 | 2 |
| ZrO₂ | 5.2 | 5.2 | 5.2 | 5.2 | 2.6 | 5.2 | 5.2 |
| Nb₂O₅ | 5.2 | 6 | 5.6 | 4.9 | 6 | 3 | 3 |
| La₂O₃ | 6.9 | 7.9 | 7.4 | 6.5 | 7.9 | 4 | 4 |
| TiO₂ | 0 | 0 | 0 | 0 | 2.6 | 6.9 | 6.9 |
| Total | 100 | 100 | 100 | 100 | 100 | 100 | 100 |
| RI at 519 nm | 1.705 | 1.723 | 1.712 | 1.693 | 1.727 | 1.699 | |
| RI at 589.3 nm | 1.698 | 1.715 | 1.705 | 1.686 | 1.719 | 1.691 | |
| RI at 633 nm | 1.695 | 1.712 | 1.701 | 1.682 | 1.716 | 1.688 | |
| Density | 3.44 | 3.54 | 3.49 | 3.38 | 3.52 | 3.2 | |
| (g/cm\hat{ }3) | | | | | | | |
| Strain point | 538 | 543 | 544 | 543 | 532 | 523 | |
| (° C.) | | | | | | | |
| Annealing | 573 | 578 | 580 | 579 | 567 | 558 | |
| point (° C.) | | | | | | | |
| Int liquidus | 1140 | 1230 | 1255 | 1265 | 1225 | 1030 | 1075 |
| (° C.) | | | | | | | |
| η_{liq} (poise) | 53 | 17 | 25 | 22 | 14 | 195 | |
| Liq phase | Lanthanum | Lanthanum | Lanthanum | Lanthanum | Lanthanum | Lithium | |
| | niobate | niobate | niobate | niobate | niobate | sodium | |
| | | | | | | lanthanum | |
| | | | | | | titanate/ | |
| | | | | | | Lanthanum | |
| | | | | | | niobate | |
| Young's | 101.1 | 102.7 | 102.0 | 100.0 | 101.8 | 100.8 | 98.7 |
| modulus | | | | | | | |
| (GPa) | | | | | | | |
| Shear | 40.5 | 41.0 | 40.7 | 40.0 | 40.5 | 40.5 | 39.7 |
| modulus | | | | | | | |
| (GPa) | | | | | | | |
| Poissons | 0.251 | 0.254 | 0.253 | 0.249 | 0.256 | 0.244 | 0.242 |
| ratio | | | | | | | |
| K_{IC} | — | 0.72 | 0.73 | 0.75 | 0.76 | 0.79 | 0.75 |
| (MPa · m\hat{ }0.5) | | | | | | | |

FIGS. 3 through 7 show data for specific compositions from Table 1.

FIG. 3 shows refractive index as a function of mol % Nb₂O₅ plus mol % La₂O₃, for various compositions.

FIG. 4 shows transmittance at wavelengths across the visible spectrum and more for a sample of Composition 30 having a 1.0 mm thickness.

FIG. 5 shows a differential scanning calorimetry (DSC) analysis for Compositions 26, 29 and 30.

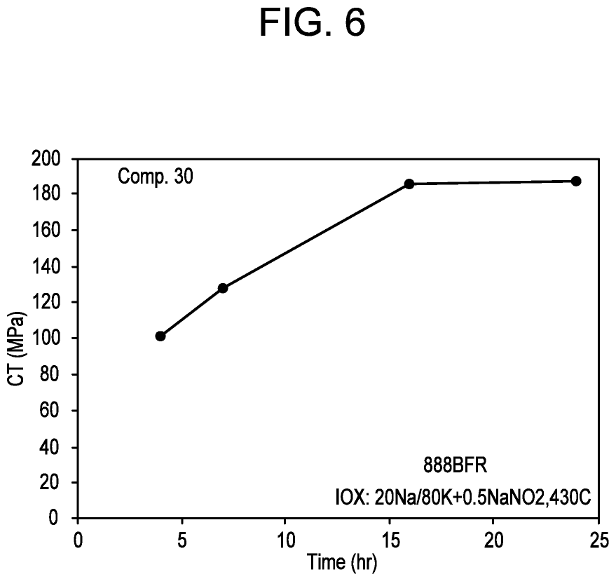

FIG. 6 shows Central Tension (CT) for a 0.8 mm thick sample of Composition 30 after ion exchange in a bath of 20 NaNO₃/80 KNO₃/0.5 NaNO₃ at 430° C. for various time periods.

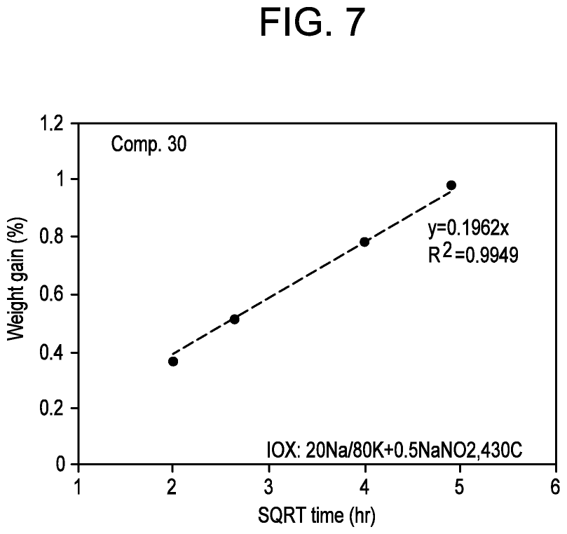

FIG. 7 shows weight gain for a 0.8 mm thick sample of Composition 30 after ion exchange in a bath of 20 NaNO₃/80 KNO₃/0.5 NaNO₃ at 430° C. for various time periods.

1. A glass, comprising:
greater than or equal to 30 mol % to less than or equal to 70 mol % SiO₂,
greater than or equal to 0 mol % to less than or equal to 10 mol % B₂O₃,
greater than or equal to 1.1 mol % to less than or equal to 12 mol % Al₂O₃,
greater than or equal to 3 mol % to less than or equal to 35 mol % Li₂O,
greater than or equal to 0 mol % to less than or equal to 20 mol % Na₂O,
greater than or equal to 0 mol % to less than or equal to 5 mol % K₂O,
greater than or equal to 0 mol % to less than or equal to 5 mol % MgO,
greater than or equal to 0 mol % to less than or equal to 5 mol % CaO,
greater than or equal to 0 mol % to less than or equal to 5 mol % SrO,
greater than or equal to 0 mol % to less than or equal to 5 mol % BaO,
greater than or equal to 0 mol % to less than or equal to 5 mol % WO₃,
greater than or equal to 0 mol % to less than or equal to 5 mol % Y₂O₃,
greater than or equal to 1 mol % to less than or equal to 15 mol % ZrO₂,
greater than or equal to 0.1 mol % to less than or equal to 20 mol % Nb₂O₅,
greater than or equal to 1 mol % to less than or equal to 20 mol % La₂O₃,
greater than or equal to 1 mol % to less than or equal to 20 mol % TiO₂.

2. The glass of claim 1, comprising greater than or equal to 56 mol % to less than or equal to 62 mol % SiO₂.

3. The glass of claim 1, comprising greater than or equal to 1 mol % to less than or equal to 9 mol % B₂O₃.

4. The glass of claim 1, comprising greater than or equal to 2 mol % to less than or equal to 9 mol % Al₂O₃.

5. The glass of claim 1, comprising greater than or equal to 6 mol % to less than or equal to 26 mol % Li₂O.

6. The glass of claim 1, comprising greater than or equal to 1 mol % to less than or equal to 15 mol % Na₂O.

7. (canceled)

8. The glass of claim 1, comprising greater than or equal to 0.1 mol % to less than or equal to 1 mol % K₂O.

9. (canceled)

10. The glass of claim 1, comprising greater than or equal to 0.1 mol % to less than or equal to 1 mol % MgO.

11. (canceled)

12. The glass of claim 1, comprising greater than or equal to 0.1 mol % to less than or equal to 2 mol % CaO.

13. (canceled)

14. The glass of claim 1, comprising greater than or equal to 0.1 mol % to less than or equal to 1 mol % SrO.

15. (canceled)

16. The glass of claim 1, comprising greater than or equal to 0.1 mol % to less than or equal to 1 mol % BaO.

17. (canceled)

18. The glass of claim 1, comprising greater than or equal to 0 mol % to less than or equal to 5 mol % RO.

19. The glass of claim 1, wherein the glass is substantially free of WO₃.

20. The glass of claim 1, wherein the glass is substantially free of Y₂O₃.

21. The glass of claim 1, comprising greater than or equal to 2 mol % to less than or equal to 6 mol % ZrO₂.

22. The glass of claim 1, comprising greater than or equal to 3 mol % to less than or equal to 11 mol % Nb₂O₅.

23. The glass of claim 1, comprising greater than or equal to 2 mol % to less than or equal to 14 mol % La₂O₃.

24. The glass of claim 1, comprising greater than or equal to 2 mol % to less than or equal to 7 mol % TiO₂.

25. The glass of claim 1, comprising:
greater than or equal to 56 mol % to less than or equal to 62 mol % SiO₂,
greater than or equal to 0 mol % to less than or equal to 9 mol % B₂O₃,
greater than or equal to 1.1 mol % to less than or equal to 9 mol % Al₂O₃,
greater than or equal to 6 mol % to less than or equal to 26 mol % Li₂O,
greater than or equal to 0 mol % to less than or equal to 15 mol % Na₂O,
greater than or equal to 0 mol % to less than or equal to 1 mol % K₂O,
greater than or equal to 0 mol % to less than or equal to 1 mol % MgO,
greater than or equal to 0 mol % to less than or equal to 2 mol % CaO,
greater than or equal to 0 mol % to less than or equal to 1 mol % SrO,
greater than or equal to 0 mol % to less than or equal to 1 mol % BaO,
greater than or equal to 1 mol % to less than or equal to 6 mol % ZrO₂,
greater than or equal to 3 mol % to less than or equal to 11 mol % Nb₂O₅,
greater than or equal to 1 mol % to less than or equal to 14 mol % La₂O₃,
greater than or equal to 1 mol % to less than or equal to 7 mol % TiO₂,
wherein the glass is substantially free of of WO₃, Y₂O₃ and BaO.

26. The glass of claim 1 any of claims 1 through 25, wherein:
ZrO₂+Nb₂O₅+La₂O₃+TiO₂+WO₃ is equal to or greater than 8 mol %.

27. The glass of claim 26, wherein:
ZrO₂+Nb₂O₅+La₂O₃+TiO₂+WO₃ is equal to or greater than 9 mol %.

28. The glass of claim 27, wherein:
ZrO₂+Nb₂O₅+La₂O₃+TiO₂+WO₃ is equal to or greater than 10 mol %.

29. The glass of claim 1, wherein the glass has a refractive index:
RI at 519 nm greater than or equal to 1.6;
RI at 589.3 nm greater than or equal to 1.6; and
RI at 633 nm greater than or equal to 1.6.

30. An ion-exchanged glass-based lens, comprising:
a compressive stress layer extending from a surface of the glass-based article to a depth of compression;
a central tension region; and
a composition at a center of the glass-based lens comprising the composition of the glass of claim 1.
